(19) United States
(12) Patent Application Publication
(10) Pub. No.: US 2017/0293494 A1
(43) Pub. Date: Oct. 12, 2017

(54) METHOD AND DEVICE FOR STARTING APPLICATION INTERFACE

(71) Applicant: Beijing Xiaomi Mobile Software Co., Ltd., Beijing (CN)

(72) Inventors: Hai LONG, Beijing (CN); Hongjie LIU, Beijing (CN); Jinshi SONG, Beijing (CN)

(73) Assignee: Beijing Xiaomi Mobile Software Co., Ltd.

(21) Appl. No.: 15/481,056

(22) Filed: Apr. 6, 2017

(30) Foreign Application Priority Data
Apr. 7, 2016 (CN) 201610213431.5

(51) Int. Cl. G06F 9/44; G06F 3/0482

(52) U.S. Cl. CPC G06F 9/4443; G06F 3/0482

(57) ABSTRACT

A method for starting an application interface on a device, includes: receiving, in a first application interface, a starting instruction for a second application interface; determining whether the first application interface is currently interacting with the second application interface; and if it is determined that the first application interface is not currently interacting with the second application interface, starting the second application interface.

### CROSS-REFERENCE TO RELATED APPLICATIONS

This application is based upon and claims priority to Chinese Patent Application No. 201610213431.5, filed on Apr. 7, 2016, the entire contents of which are incorporated herein by reference.

### TECHNICAL FIELD

The present disclosure generally relates to the field of electronic equipment, and more particularly, to a method and device for starting an application interface.

### BACKGROUND

Along with rapid development of smart terminals, there are more and more diversified application interfaces on a terminal. In order to conveniently switch between interfaces, a terminal may provide, in an application interface, a starting option for another application interface for conveniently switching from the application interface to the other application interface.

For example, for a first application interface and a second application interface, when a terminal displays the first application interface, a starting option for the second application interface is provided, and if a user wants to start the second application interface, the starting option may be clicked to trigger a starting instruction for the second application interface. When the terminal receives the starting instruction, a suspending instruction is sent to the first application interface at first, and after a period of time, when the first application interface is in a suspended state and returns a suspending response, the second application interface is started.

### SUMMARY

According to a first aspect of the present disclosure, there is provided a method for starting an application interface on a device, comprising: receiving, in a first application interface, a starting instruction for a second application interface; determining whether the first application interface is currently interacting with the second application interface; and if it is determined that the first application interface is not currently interacting with the second application interface, starting the second application interface.

According to a second aspect of the present disclosure, there is provided a device for starting an application interface, comprising: a processor; and a memory configured to store instructions executable by the processor, wherein the processor is configured to: receive, in a first application interface, a starting instruction for a second application interface; determine whether the first application interface is currently interacting with the second application interface; and if it is determined that the first application interface is not currently interacting with the second application interface, start the second application interface.

According to a third aspect of the present disclosure, there is provided a non-transitory computer-readable storage medium having stored therein instructions that, when executed by a processor of a device, cause the device to perform a method for starting an application interface, the method comprising: receiving, in a first application interface, a starting instruction for a second application interface; determining whether the first application interface is currently interacting with the second application interface; and if it is determined that the first application interface is not currently interacting with the second application interface, starting the second application interface.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of the present disclosure.

FIG. 1 is a flow chart of a method for starting an application interface according to an exemplary embodiment.

FIG. 2 is a flow chart of a method for starting an application interface according to another exemplary embodiment.

FIG. 3 is a flow chart of a method for starting an application interface according to yet another exemplary embodiment.

FIG. 4 is a block diagram of a device for starting an application interface according to an exemplary embodiment.

FIG. 5 is a block diagram of a device for starting an application interface according to another exemplary embodiment.

### DETAILED DESCRIPTION

Exemplary embodiments will now be described in detail, examples of which are illustrated in the accompanying drawings. The following description refers to the accompanying drawings, in which like numerals refer to the same or similar elements unless otherwise indicated. The implementations described in the following exemplary embodiments do not represent all implementations consistent with the present disclosure. Rather, they are merely examples of devices and methods consistent with some aspects of the present disclosure as detailed in the appended claims.

In the present disclosure, a home interface is a system desktop provided by a terminal, i.e., an interface displayed when the terminal is started or when a user clicks a home key provided by the terminal.

In the present disclosure, an activity is a standard component for an Android platform. For example, an activity is a single screen in an application and is inherited from an activity class. The activity displays a user interface (UI) formed by views and a response event.

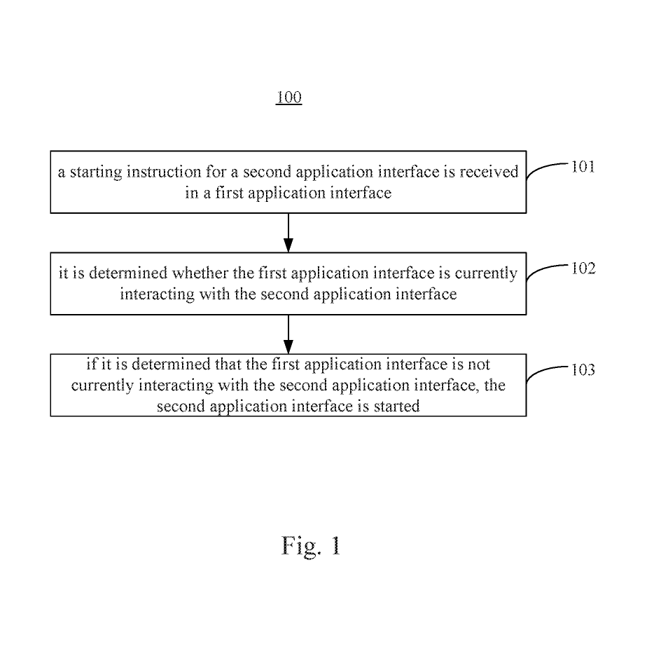

FIG. 1 is a flow chart of a method 100 for starting an application interface according to an exemplary embodiment. For example, the method 100 may be applied to a terminal. Referring to FIG. 1, the method 100 includes the following steps.

In step 101, a starting instruction for a second application interface is received in a first application interface.

In step 102, it is determined whether the first application interface is currently interacting with the second application interface.

In step 103, if it is determined that the first application interface is not currently interacting with the second application interface, the second application interface is started.

According to the method 100, when the starting instruction for the second application interface is received in the first application interface, it is determined whether the first application interface is currently interacting with the second application interface, and if it is determined that the first application interface is not currently interacting with the second application interface, the second application interface may be directly started instead of being started after waiting until the first application interface is in a suspended state, so that internal logic disorder in the terminal may be avoided, user waiting time may also be saved, and a starting speed of the second application interface may be improved.

In one embodiment, step 102 includes: determining whether the starting instruction includes a main interface starting identifier, the main interface starting identifier being configured to indicate that an application interface triggering the starting instruction is a home interface; and if the starting instruction includes the main interface starting identifier, determining that the first application interface is not currently interacting with the second application interface.

In one embodiment, step 102 includes: determining whether the first application interface is an activity interface; and if the first application interface is not the activity interface, determining that the first application interface is not currently interacting with the second application interface.

In one embodiment, step 102 includes: determining whether the first application interface and the second application interface are in different processes; and if the first application interface and the second application interface are in different processes, determining that the first application interface is not currently interacting with the second application interface.

In one embodiment, step 102 includes: determining whether the starting instruction includes the main interface starting identifier; if the starting instruction does not include the main interface starting identifier, determining whether the first application interface is an activity interface; if the first application interface is the activity interface, determining whether the first application interface and the second application interface are in different processes; and if the first application interface and the second application interface are in the same process, determining that the first application interface is currently interacting with the second application interface.

In one embodiment, the method 100 further includes: if it is determined that the first application interface is currently interacting with the second application interface, starting the second application interface after it is determined that the first application interface is in a suspended state.

All of the above embodiments may be freely combined to form an embodiment, which will not be elaborated herein.

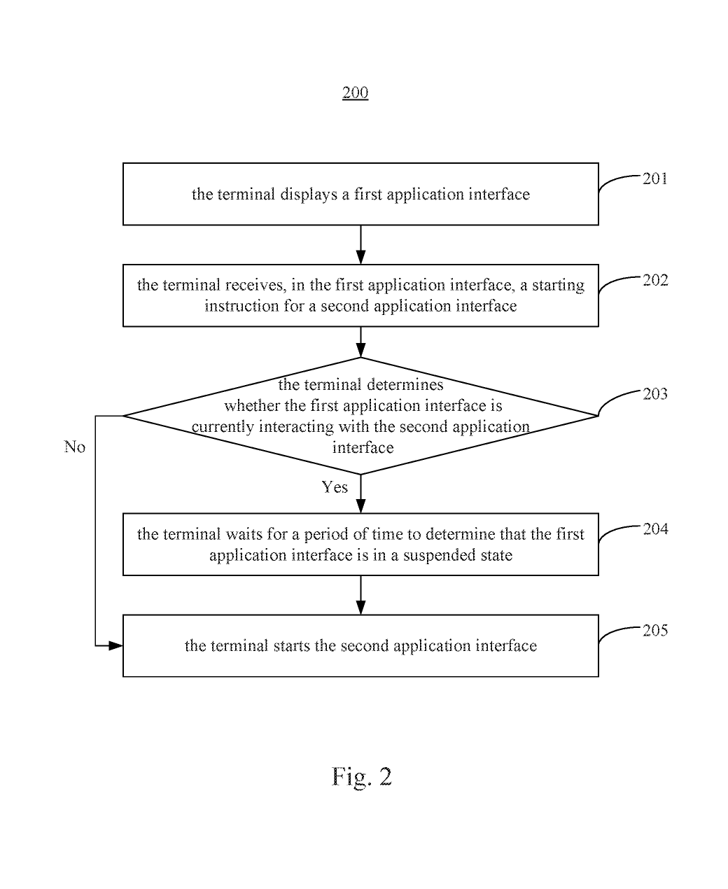

FIG. 2 is a flow chart of a method 200 for starting an application interface according to an exemplary embodiment. For example, the method 200 may be applied to a terminal. Referring to FIG. 2, the method 200 includes the following steps.

In step 201, the terminal displays a first application interface.

For example, the terminal may be a mobile phone, a computer, a tablet computer, etc., and multiple applications may run on the terminal. These applications may include a desktop application, a notification bar application, a Bluetooth (BT) application, a chatting application, a shopping application and the like. There are no limits to the terminal and the applications on the terminal in the present disclosure.

In the embodiment, the first application interface and a second application interface may be any different application interfaces on the terminal. For example, the first application interface and the second application interface may be interfaces of different applications, and may also be different interfaces of the same application.

When the terminal displays the first application interface, a user may operate in the first application interface. For example, when the first application is a desktop application, the terminal displays a home interface, and the user may view an application icon list in the home interface. Also for example, when the first application interface is a contact interface of a chatting application, the user may view contacts or select any contact for chatting in the contact interface.

In step 202, the terminal receives, in the first application interface, a starting instruction for the second application interface.

For example, the first application interface may include a starting option of the second application interface, so that the user may click the starting option to trigger the starting instruction for the second application interface when the user wants to switch the terminal from the first application interface to the second application interface. Accordingly, the terminal receives, in the first application interface, the starting instruction for the second application interface.

The starting option may be an option in the form of a button, an icon and the like, which is not limited in the present disclosure.

For example, when the first application interface is a home interface including icons of multiple applications, the user may click the icon of a second application to trigger the starting instruction for the second application interface to start the second application interface. Also for example, when the first application interface is a chatting interface with a contact in a chatting application, the user may receive a web link sent by the contact in the chatting interface and the web link is configured to turn to an interface of a shopping application, and the user may click the web link to trigger a starting instruction for the interface of the shopping application.

In step 203, the terminal determines whether the first application interface is currently interacting with the second application interface. The terminal executes step 204 if the first application interface is (203—Yes), and executes step 205 if not (203—No).

In step 204, the terminal waits for a period of time to determine that the first application interface is in a suspended state.

In step 205, the terminal starts the second application interface.

In the related art, as noted above, logic disorder may be caused and then normal running of the terminal may be influenced by directly starting the second application interface upon reception of the starting instruction, if the first application interface is currently interacting with the second application interface. Thus, the terminal sends a suspending instruction to the first application interface at first when receiving the starting instruction. The first application interface receives the suspending instruction, and returns a suspending response when finishing a current interface operation and entering the suspended state. At this moment, the terminal determines that the first application interface is in the suspended state and does not interact with the second application interface, and then starts the second application interface. In the above process, the terminal always waits for a period of time after receiving the starting instruction, and starts the second application interface only when determining that the first application interface is in the suspended state.

In the method 200, in order to increase a starting speed of the second application interface, the terminal determines whether the first application interface is currently interacting with the second application interface at first when receiving the starting instruction, and determines whether to wait according to a determination result.

If the first application interface is currently interacting with the second application interface, for avoiding internal logic disorder and maintaining an original logic of the first application interface, the terminal waits for a period of time, and starts the second application interface after determining that the first application interface is in the suspended state. For example, the terminal sends a suspending instruction to the first application interface, and starts the second application interface when the first application interface returns a suspending response.

In some embodiments, if the terminal does not receive the suspending response returned by the first application interface within a preset time length after sending the suspending instruction to the first application interface, the second application interface may also be started.

If the first application interface is not currently interacting with the second application interface, the terminal directly starts the second application interface without waiting for a period of time after receiving the starting instruction. At this moment, the terminal may still send the suspending instruction to the first application interface to indicate the first application interface to be suspended.

In exemplary embodiments, different manners may be adopted for determining whether the first application interface is currently interacting with the second application interface. For example, a determination process may include at least one of the following step 1 to step 3.

In step 1, it is determined whether the starting instruction includes a main interface starting identifier.

For example, the main interface starting identifier is configured to indicate an application interface triggering the starting instruction is a home interface, and if a starting instruction for an application interface is triggered on the home interface, the starting instruction may include the main interface starting identifier. The main interface starting identifier may be a preset field or a segment of preset data in the starting instruction, which is not limited in the present disclosure.

If the starting instruction includes the main interface starting identifier, it indicates that the first application interface is the home interface and the user triggers the starting instruction for the second application interface on the home interface. Since the home interface is usually configured to start other application interfaces, and does not often interact with other application interfaces, it may be determined that the first application interface is not currently interacting with the second application interface, starting the second application interface may not affect a desktop application or cause logic disorder, and the second application interface may be directly started.

If the starting instruction does not include the main interface starting identifier, it indicates that the first application interface is not the home interface, and at this moment, it is uncertain that the first application interface is not currently interacting with the second application interface. Accordingly, the terminal determines that the first application interface may be currently interacting with the second application interface, and executes steps 204 and 205 to wait for a period of time and start the second application interface after determining that the first application interface is in the suspended state. The terminal may also execute the following step 2 or step 3 to continue determining whether the first application interface is currently interacting with the second application interface.

In step 2, it is determined whether the first application interface is an activity interface.

For example, the activity interface may include an interface of a chatting application, or an interface of a payment application, which is not limited in the present disclosure.

If the first application interface is not the activity interface, it indicates that the first application interface usually does not often interact with other application interfaces. Accordingly, it may be determined that the first application interface is not currently interacting with the second application interface, starting the second application interface may not affect system running or cause logic disorder, and the second application interface may be directly started.

If the first application interface is the activity interface, it is uncertain that the first application interface is not currently interacting with the second application interface. Accordingly, the terminal determines that the first application interface may be currently interacting with the second application interface, and executes steps 204 and 205 to wait for a period of time and start the second application interface after determining that the first application interface is in the suspended state. The terminal may also execute the following step 3 to continue determining whether the first application interface is currently interacting with the second application interface.

In step 3, it is determined whether the first application interface and the second application interface are in different processes.

For example, each process on the terminal may run one or more application interfaces, and if more than two application interfaces run in the same process, it indicates that these application interfaces have associated data and may currently interact with one another.

If the first application interface and the second application interface are in different processes, it may be determined that the first application interface is not currently interacting with the second application interface, starting the second application interface may not affect system running or cause logic disorder, and the second application interface may be directly started.

If the first application interface and the second application interface are in the same process, it is uncertain that the first application interface is not currently interacting with the second application interface. Accordingly, the terminal determines that the first application interface may be currently interacting with the second application interface, and executes steps 204 and 205 to wait for a period of time and start the second application interface after determining that the first application interface is in the suspended state.

In addition, a task queue may be maintained in a process to execute multiple tasks in the task queue, and if two application interfaces in the same process are in the same task, it indicates that the two application interfaces have associated data and may currently interact with each other. If two application interfaces in the same process are in different tasks, it may be determined that the two application interfaces are not currently interacting.

Therefore, when it is determined that the first application interface and the second application interface are in the same process, it is further determined whether the first application interface and the second application interface are in the same task of the process. It is determined that the first application interface is currently interacting with the second application interface if the first application interface and the second application interface are in the same task, and it is determined that the first application interface is not currently interacting with the second application interface if the first application interface and the second application interface are in different tasks.

It should be noted that the terminal may adopt any one or more manners in step 1 to step 3 to determine whether the first application interface is currently interacting with the second application interface.

For example, when it is determined in a manner that the first application interface may currently interact with the second application interface, determination may be continued in another manner, and the second application interface may be directly started if it is determined in a manner that the first application interface is not currently interacting with the second application interface. When it is determined that the first application interface may currently interact with the second application interface in all of the manners based on step 1 to step 3, it may finally be determined that the first application interface is currently interacting with the second application interface, and the second application interface may be started only after the first application interface is in the suspended state.

The terminal may make such determination in the manners based on step 1 to step 3, and start the second application interface only when determining that the first application interface is not currently interacting with the second application interface in all of the manners. If it is determined in a manner that the first application interface may currently interact with the second application interface, it is determined that the first application interface is currently interacting with the second application interface, and the second application interface may be started only after the first application interface is in the suspended state.

In exemplary embodiments, step 202 to step 205 may be executed by an operating system of the terminal. For example, when the user triggers the starting instruction for the second application interface in the first application interface, the first application interface sends the starting instruction to the operating system, and the operating system determines whether the first application interface is currently interacting with the second application interface when receiving the starting instruction. If so, the operating system sends the suspending instruction to the first application interface, and starts the second application interface, after the first application interface returns the suspending response and it is determined that the first application interface is in the suspended state. If not, the operating system directly starts the second application interface without waiting.

In the method 200, when the starting instruction for the second application interface is received in the first application interface, the starting instruction is analyzed, and it is determined under different application scenarios whether the first application interface is currently interacting with the second application interface. The second application interface is directly started instead of being started after waiting until the first application interface is in the suspended state, if the first application interface is not currently interacting with the second application interface. Otherwise, the second application interface is started after the first application interface is in the suspended state, so that a starting operation may be dynamically managed to avoid internal logic disorder of the terminal, save user waiting time, and improve the starting speed of the second application interface.

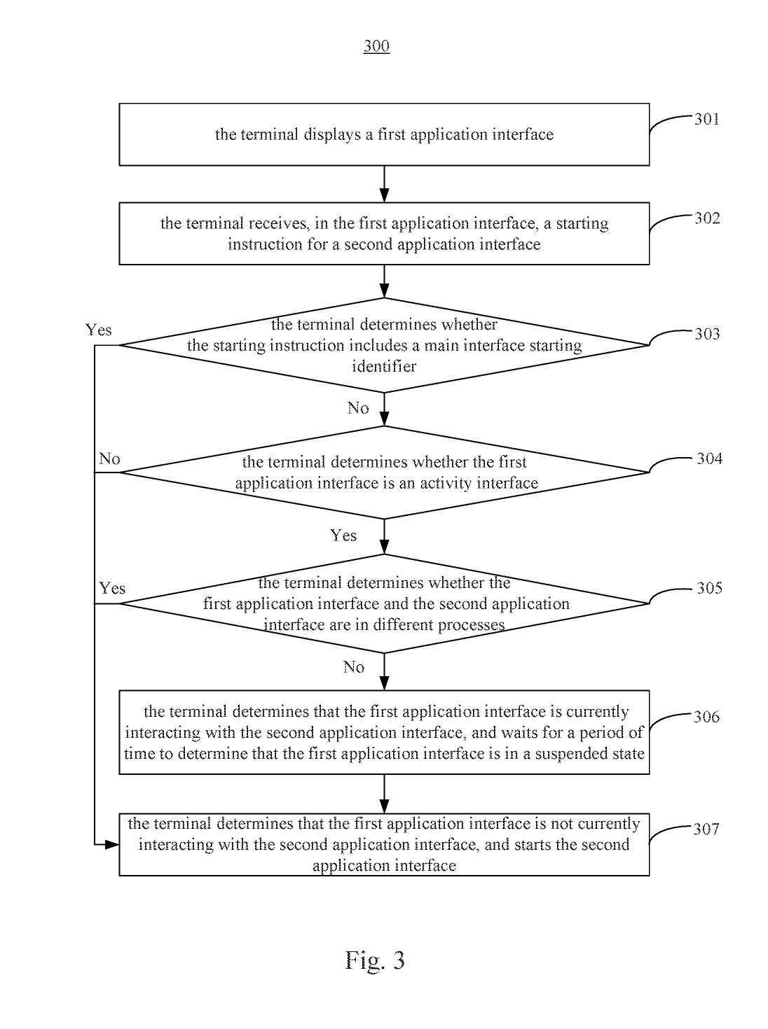

FIG. 3 is a flow chart of a method 300 for starting an application interface according to an exemplary embodiment. For example, the method 300 may be applied to a terminal. Referring to FIG. 3, the method 300 includes the following steps.

In step 301, the terminal displays a first application interface.

In step 302, the terminal receives, in the first application interface, a starting instruction for a second application interface.

In step 303, the terminal determines whether the starting instruction includes a main interface starting identifier, executes step 307 if the terminal determines that the starting instruction includes a main interface starting identifier (303—Yes), and executes step 304 if not (303—No).

If the starting instruction includes the main interface starting identifier, it may be directly determined that the first application interface is not currently interacting with the second application interface.

However, if the starting instruction does not include the main interface starting identifier, it may not be determined that the first application interface is currently interacting with the second application interface, and it is further determined whether the first application interface is an activity interface to improve determination accuracy.

In step 304, the terminal determines whether the first application interface is the activity interface, executes step 305 if the terminal determines that the first application interface is the activity interface (304—Yes), and executes step 307 if not (304—No).

If the first application interface is not the activity interface, it may be directly determined that the first application interface is not currently interacting with the second application interface.

However, if the first application interface is the activity interface, it may not be determined that the first application interface is currently interacting with the second application interface, and it is further determined whether the first application interface and the second application interface are in different processes, to improve determination accuracy.

In step 305, the terminal determines whether the first application interface and the second application interface are in different processes, executes step 307 if the terminal determines that the first application interface and the second application interface are in different processes (305—Yes), and executes step 306 if not (305—No).

If the first application interface and the second application interface are in different processes, it may be directly determined that the first application interface is not currently interacting with the second application interface.

If the first application interface and the second application interface are in the same process, considering that the starting instruction does not include the main interface starting identifier and the first application interface is the activity interface, the first application interface may currently interact with the second application interface, and at this moment, it may be determined that the first application interface is currently interacting with the second application interface.

In step 306, the terminal determines that the first application interface is currently interacting with the second application interface, and waits for a period of time to determine that the first application interface is in a suspended state.

In step 307, the terminal determines that the first application interface is not currently interacting with the second application interface, and starts the second application interface.

In the method 300, when it is determined whether the first application interface is currently interacting with the second application interface, multiple manners are combined for determination, so that determination accuracy may be improved, internal logic disorder of the terminal may be avoided, user waiting time may be saved, and a starting speed of the second application interface may be increased.

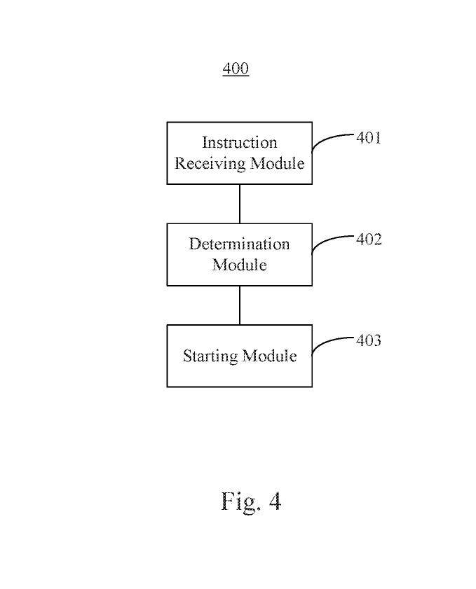

FIG. 4 is a block diagram of a device 400 for starting an application interface according to an exemplary embodiment. Referring to FIG. 4, the device 400 includes an instruction receiving module 401, a determination module 402, and a starting module 403.

The instruction receiving module 401 is configured to receive, in a first application interface, a starting instruction for a second application interface.

The determination module 402 is configured to determine whether the first application interface is currently interacting with the second application interface.

The starting module 403 is configured to, if it is determined that the first application interface is not currently interacting with the second application interface, start the second application interface.

In one embodiment, the determination module 402 is configured to determine whether the starting instruction includes a main interface starting identifier, the main interface starting identifier being configured to indicate that an application interface triggering the starting instruction is a home interface; and if the starting instruction includes the main interface starting identifier, determine that the first application interface is not currently interacting with the second application interface.

In one embodiment, the determination module 402 is configured to determine whether the first application interface is an activity interface; and if the first application interface is not the activity interface, determine that the first application interface is not currently interacting with the second application interface.

In one embodiment, the determination module 402 is configured to determine whether the first application interface and the second application interface are in different processes; and if the first application interface and the second application interface are in different processes, determine that the first application interface is not currently interacting with the second application interface.

In one embodiment, the determination module 402 is configured to determine whether the starting instruction includes the main interface starting identifier; if the starting instruction does not include the main interface starting identifier, determine whether the first application interface is the activity interface; if the first application interface is the activity interface, determine whether the first application interface and the second application interface are in different processes; and if the first application interface and the second application interface are in the same process, determine that the first application interface is currently interacting with the second application interface.

In one embodiment, the starting module 403 is further configured to, if it is determined that the first application interface is currently interacting with the second application interface, start the second application interface after it is determined that the first application interface is in a suspended state.

All of the above embodiments may be freely combined to form an embodiment, which will not be elaborated herein.

With respect to the device 400 in the above embodiments, the specific manners for performing operations for individual modules therein have been described in detail in the embodiments regarding the methods, which will not be repeated herein.

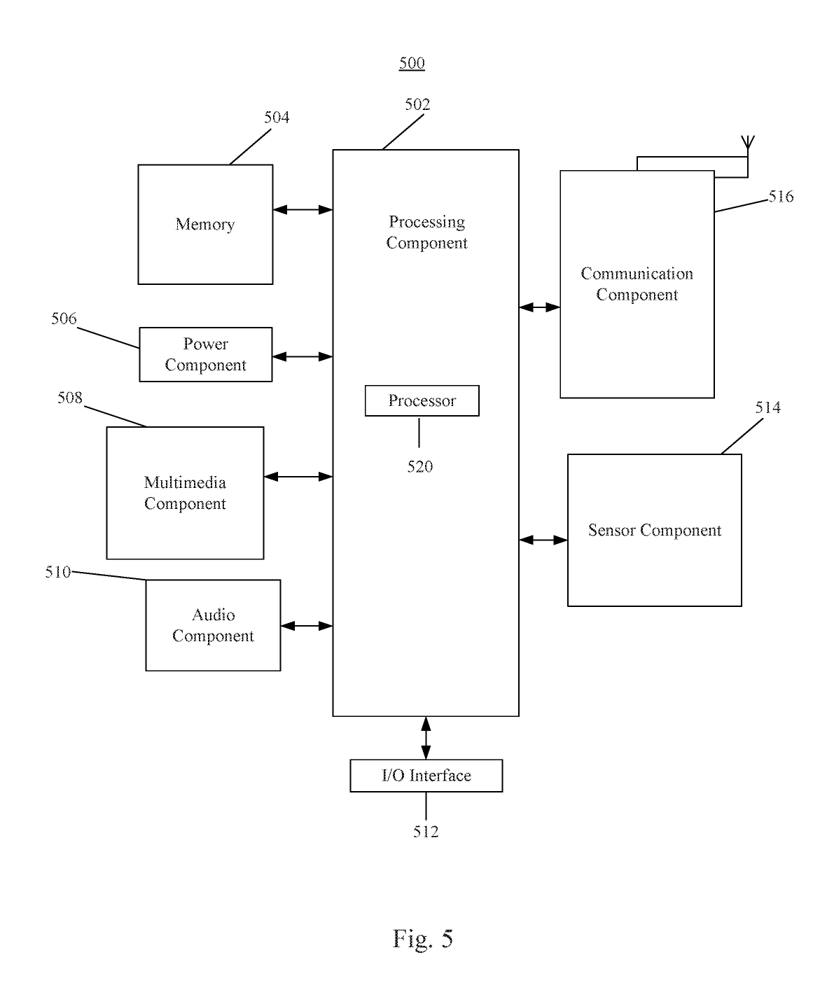

FIG. 5 is a block diagram of a device 500 for starting an application interface according to another exemplary embodiment of the present disclosure. For example, the device 500 may be a mobile phone, a computer, a digital broadcast terminal, a messaging device, a gaming console, a tablet, a medical device, exercise equipment, a personal digital assistant (PDA) and the like.

Referring to FIG. 5, the device 500 may include one or more of the following components: a processing component 502, a memory 504, a power component 506, a multimedia component 508, an audio component 510, an Input/Output (I/O) interface 512, a sensor component 514, and a communication component 516.

The processing component 502 typically controls overall operations of the device 500, such as the operations associated with display, telephone calls, data communications, camera operations, and recording operations. The processing component 502 may include one or more processors 520 to execute instructions to perform all or part of the steps in the abovementioned method. Moreover, the processing component 502 may include one or more modules which facilitate interaction between the processing component 502 and the other components. For instance, the processing component 502 may include a multimedia module to facilitate interaction between the multimedia component 508 and the processing component 502.

The memory 504 is configured to store various types of data to support the operation of the device 500. Examples of such data include instructions for any application programs or methods operated on the device 500, contact data, phonebook data, messages, pictures, video, etc. The memory 504 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 506 provides power for various components of the device 500. The power component 506 may include a power management system, one or more power supplies, and other components associated with the generation, management and distribution of power for the device 500.

The multimedia component 508 includes a screen providing an output interface between the device 500 and a user. In some embodiments, the screen may include a Liquid Crystal Display (LCD) and a Touch Panel. If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia component 508 includes a front camera and/or a rear camera. The front camera and/or the rear camera may receive external multimedia data when the device 500 is in an operation mode, such as a photographing mode or a video mode. Each of the front camera and the rear camera may be a fixed optical lens system or have focusing and optical zooming capabilities.

The audio component 510 is configured to output and/or input an audio signal. For example, the audio component 510 includes a microphone configured to receive an external audio signal when the device 500 is in the operation mode, such as a call mode, a recording mode and a voice recognition mode. The received audio signal may be further stored in the memory 504 or sent through the communication component 516. In some embodiments, the audio component 510 further includes a speaker configured to output the audio signal.

The I/O interface 512 provides an interface between the processing component 502 and a peripheral interface module, and the peripheral interface module may be a keyboard, a click wheel, a button and the like. The button may include, but not limited to: a home button, a volume button, a starting button and a locking button.

The sensor component 514 includes one or more sensors configured to provide status assessment in various aspects for the device 500. For instance, the sensor component 514 may detect an on/off status of the device 500 and relative positioning of components, such as a display and small keyboard of the device 500, and the sensor component 514 may further detect a change in a position of the device 500 or a component of the device 500, presence or absence of contact between the user and the device 500, orientation or acceleration/deceleration of the device 500 and a change in temperature of the device 500. The sensor component 514 may include a proximity sensor configured to detect presence of an object nearby without any physical contact. The sensor component 514 may also include a light sensor, such as a Complementary Metal Oxide Semiconductor (CMOS) or Charge Coupled Device (CCD) image sensor configured for use in an imaging application. In some embodiments, the sensor component 514 may also include an acceleration sensor, a gyroscope sensor, a magnetic sensor, a pressure sensor or a temperature sensor.

The communication component 516 is configured to facilitate wired or wireless communication between the device 500 and another device. The device 500 may access a communication-standard-based wireless network, such as a Wireless Fidelity (WiFi) network, a 2nd-Generation (2G), 3rd-Generation (3G) or 4th-Generation (4G) network or a combination thereof. In an exemplary embodiment, the communication component 516 receives a broadcast signal or broadcast associated information from an external broadcast management system through a broadcast channel. In an exemplary embodiment, the communication component 516 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BT technology and another technology.

In an exemplary embodiment, the device 500 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method for starting the application interface.

In an exemplary embodiment, there is also provided a non-transitory computer-readable storage medium including instructions, such as included in the memory 504. The instructions, when executed by the processor 520 of the device 500, cause the device 500 to perform the above described methods for starting the application interface. For example, the non-transitory computer-readable storage medium may be a ROM, a compact disc read-only memory (CD-ROM), a magnetic tape, a floppy disc, an optical data storage device and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A method for starting an application interface on a device, comprising:
receiving, in a first application interface, a starting instruction for a second application interface;
determining whether the first application interface is currently interacting with the second application interface; and
if it is determined that the first application interface is not currently interacting with the second application interface, starting the second application interface.

2. The method according to claim 1, wherein determining whether the first application interface is currently interacting with the second application interface comprises:
determining whether the starting instruction includes a main interface starting identifier, wherein the main interface starting identifier is configured to indicate that an application interface triggering the starting instruction is a home interface; and
if it is determined that the starting instruction includes the main interface starting identifier, determining that the first application interface is not currently interacting with the second application interface.

3. The method according to claim 1, wherein determining whether the first application interface is currently interacting with the second application interface comprises:
determining whether the first application interface is an activity interface; and
if it is determined that the first application interface is not the activity interface, determining that the first application interface is not currently interacting with the second application interface.

4. The method according to claim 1, wherein determining whether the first application interface is currently interacting with the second application interface comprises:
determining whether the first application interface and the second application interface are in different processes; and
if it is determined that the first application interface and the second application interface are in different processes, determining that the first application interface is not currently interacting with the second application interface.

5. The method according to claim 1, wherein determining whether the first application interface is currently interacting with the second application interface comprises:
determining whether the starting instruction includes a main interface starting identifier, wherein the main interface starting identifier is configured to indicate that an application interface triggering the starting instruction is a home interface;
if it is determined that the starting instruction does not include the main interface starting identifier, determining whether the first application interface is an activity interface;
if it is determined that the first application interface is the activity interface, determining whether the first application interface and the second application interface are in different processes; and
if it is determined that the first application interface and the second application interface are in a same process, determining that the first application interface is currently interacting with the second application interface.

6. The method according to claim 1, further comprising:
if it is determined that the first application interface is currently interacting with the second application interface, starting the second application interface after further determining that the first application interface is in a suspended state.

7. The method according to claim 5, further comprising:
after determining that the first application interface is currently interacting with the second application interface, starting the second application interface after further determining that the first application interface is in a suspended state.

8. A device for starting an application interface, comprising:
a processor; and
a memory configured to store instructions executable by the processor,
wherein the processor is configured to:
receive, in a first application interface, a starting instruction for a second application interface:
determine whether the first application interface is currently interacting with the second application interface; and
if it is determined that the first application interface is not currently interacting with the second application interface, start the second application interface.

9. The device according to claim 8, wherein in determining whether the first application interface is currently interacting with the second application interface, the processor is further configured to:
determine whether the starting instruction includes a main interface starting identifier, wherein the main interface starting identifier is configured to indicate that an application interface triggering the starting instruction is a home interface; and
if it is determined that the starting instruction includes the main interface starting identifier, determine that the first application interface is not currently interacting with the second application interface.

10. The device according to claim 8, wherein in determining whether the first application interface is currently interacting with the second application interface, the processor is further configured to:
determine whether the first application interface is an activity interface; and
if it is determined that the first application interface is not the activity interface, determine that the first application interface is not currently interacting with the second application interface.

11. The device according to claim 8, wherein in determining whether the first application interface is currently interacting with the second application interface, the processor is further configured to:
determine whether the first application interface and the second application interface are in different processes; and
if it is determined that the first application interface and the second application interface are in different processes, determine that the first application interface is not currently interacting with the second application interface.

12. The device according to claim 8, wherein in determining whether the first application interface is currently interacting with the second application interface, the processor is further configured to:
determine whether the starting instruction includes a main interface starting identifier, wherein the main interface starting identifier is configured to indicate that an application interface triggering the starting instruction is a home interface;
if it is determined that the starting instruction does not include the main interface starting identifier, determine whether the first application interface is an activity interface;
if it is determined that the first application interface is the activity interface, determine whether the first application interface and the second application interface are in different processes; and
if it is determined that the first application interface and the second application interface are in a same process, determine that the first application interface is currently interacting with the second application interface.

13. The device according to claim 8, wherein the processor is further configured to:
if it is determined that the first application interface is currently interacting with the second application interface, start the second application interface after further determining that the first application interface is in a suspended state.

14. The device according to claim 12, wherein the processor is further configured to,
after determining that the first application interface is currently interacting with the second application interface, start the second application interface after further determining that the first application interface is in a suspended state.

15. A non-transitory computer-readable storage medium having stored therein instructions that, when executed by a processor of a device, cause the device to perform a method for starting an application interface, the method comprising:
receiving, in a first application interface, a starting instruction for a second application interface;
determining whether the first application interface is currently interacting with the second application interface; and
if it is determined that the first application interface is not currently interacting with the second application interface, starting the second application interface.

16. The non-transitory computer-readable storage medium according to claim 15, wherein determining whether the first application interface is currently interacting with the second application interface comprises:
determining whether the starting instruction includes a main interface starting identifier, wherein the main interface starting identifier is configured to indicate that an application interface triggering the starting instruction is a home interface; and
if it is determined that the starting instruction includes the main interface starting identifier, determining that the first application interface is not currently interacting with the second application interface.

17. The non-transitory computer-readable storage medium according to claim 15, wherein determining whether the first application interface is currently interacting with the second application interface comprises:
determining whether the first application interface is an activity interface; and
if it is determined that the first application interface is not the activity interface, determining that the first application interface is not currently interacting with the second application interface.

18. The non-transitory computer-readable storage medium according to claim 15, wherein determining whether the first application interface is currently interacting with the second application interface comprises:
determining whether the first application interface and the second application interface are in different processes; and
if it is determined that the first application interface and the second application interface are in different processes, determining that the first application interface is not currently interacting with the second application interface.

19. The non-transitory computer-readable storage medium according to claim 15, wherein determining whether the first application interface is currently interacting with the second application interface comprises:
determining whether the starting instruction includes a main interface starting identifier, wherein the main interface starting identifier is configured to indicate that an application interface triggering the starting instruction is a home interface;
if it is determined that the starting instruction does not include the main interface starting identifier, determining whether the first application interface is an activity interface;
if it is determined that the first application interface is the activity interface, determining whether the first application interface and the second application interface are in different processes; and
if it is determined that the first application interface and the second application interface are in a same process, determining that the first application interface is currently interacting with the second application interface.

20. The non-transitory computer-readable storage medium according to claim 15, wherein the method further comprising:
if it is determined that the first application interface is currently interacting with the second application interface, starting the second application interface after further determining that the first application interface is in a suspended state.
